(19) United States
(12) Patent Application Publication
(10) Pub. No.: US 2016/0063447 A1
(43) Pub. Date: Mar. 3, 2016

(54) FILTERING CALENDAR NOTIFICATIONS

(71) Applicant: salesforce.com, inc., San Francisco, CA (US)

(72) Inventor: Jaime Raul Morales, San Francisco, CA (US)

(21) Appl. No.: 14/665,970

(22) Filed: Mar. 23, 2015

Related U.S. Application Data
(60) Provisional application No. 62/041,740, filed on Aug. 26, 2014.

(51) Int. Cl. G06Q 10/10

(52) U.S. Cl. CPC G06Q 10/1093

(57) ABSTRACT

Techniques are disclosed relating to filtering calendar notifications. In one embodiment, a computing device retrieves event information from a calendar application of the computing device. The event information identifies a plurality of events for a user of the computing device. The computing device selects one or more of the plurality of events by applying a user-defined filtering rule to the event information. The computing device presents notifications for the selected one or more events on a display. In some embodiments, the event information identifies a plurality of invitees for one of the plurality of events, and the filtering rule specifies that a notification be presented for the event based on the plurality of invitees.

This application claims the benefit of U.S. Prov. Appl. No. 62/041,740 filed on Aug. 26, 2014, which is incorporated by reference herein in its entirety.

### BACKGROUND

1. Technical Field

This disclosure relates generally to notification systems, and, more specifically, to presenting calendar notifications.

2. Description of the Related Art

Various calendar applications are in use today, including iCal™, Google™ Calendar, and Microsoft™ Outlook. These applications present an interface that allows a user to create an event at a specified time. In this manner, the user may track various events, including meetings that the user has been invited to. Some calendar applications also allow a user to send invite requests for events to other users. When an invitee receives the request, the invitee can choose to accept or decline the request. If the invitee accepts, a corresponding event is typically created in the invitee's calendar.

In some instances, a calendar application may present a notification to a user in advance of an event. For example, a notification might be presented to a user that identifies an conference call that is scheduled to begin in fifteen minutes. Such a notification serves to remind the user of the event.

### BRIEF DESCRIPTION OF THE DRAWINGS

FIG. 1 is a block diagram of one embodiment of a computing device configured to filter calendar notifications.

FIG. 2 is a block diagram illustrating one embodiment of a filtering process executable by a computing device.

FIG. 3 is a diagram illustrating an example of notification filtering.

FIG. 4 is a flow diagram illustrating one embodiment of a method for filtering calendar notifications.

FIG. 5 is a block diagram illustrating one embodiment of an exemplary computer system.

This disclosure includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. §112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in a manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

As used herein, the terms “first,” “second,” etc. are used as labels for nouns that they precede, and do not imply any type of ordering (e.g., spatial, temporal, logical, etc.). For example, a calendar may be described as having a “first” calendar event and a “second” calendar event. These labels do not refer to the ordering in which these events occur. Accordingly, it may be the case that the second calendar event occurs prior to the first calendar.

As used herein, the term “based on” is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

### DETAILED DESCRIPTION

While event notifications serve a valuable purpose, the present disclosure recognizes that receiving too many notifications can be counterproductive. (As used herein, a “notification” is intended to be interpreted according to its ordinary meaning, which includes visual or audible information that provides a message to a user (e.g., regarding an associated calendar event. In some cases, a notification may at least partially occlude underlying content.) When a large number of notifications are presented to a user, it may be difficult for the user to discern which notifications are ones that the user is interested in and which notifications can be ignored. This problem can be particularly acute in a corporate environment. In this setting, in which users routinely cause events to be added to other users' calendars, it is not uncommon for a user to have a voluminous number of events scheduled for a particular day—in some cases, more events that a user can possibly attend. This in turn leads to a voluminous, overwhelming number of notifications that are presented to the user.

The present disclosure recognizes that a particular user will often want to receive notifications for only certain events. For example, a corporate employee might wish to receive notifications for meetings with potential sales leads and not to receive notifications for internal meetings. In another case, an employee might wish to receive notifications for a meeting for which an invitation has been sent from his or her supervisor.

To address these issues, the present disclosure describes embodiments in which a user may define rules to filter which calendar notifications are presented on the user's computing device. For example, in some embodiments, a user may define a rule that dictates that notifications be presented for calendar events based on the invitees of those events (e.g., whether any of the invitees for an event are a sales lead of the user). As will be described below in further detail, in various embodiments, a filtering process may retrieve event information from a calendar application of a user and apply filtering rules defined by the user to the event information to select particular calendar events for which notifications are desired. (As used herein, the term “calendar event” refers generally to any event recorded in or accessible to a calendar application.) The filtering process may then request that the selected notifications be presented.

In some embodiments, the filtering process may perform additional tasks other than filtering notifications. Accordingly, in some embodiments, the filtering process may store records of calendar events in a database for subsequent review. In some embodiments, the filtering process may solicit additional input from a user about calendar events. For example, in one embodiment, the filtering process may cause a notification to be presented after a calendar event such that the notification directs the user to a form that collects information about the event. (Accordingly, while the phrase “filtering process” is used below to describe various features, this phase is not intended to be limited to a process whose only function is to select certain calendar events for which to present a notification.)

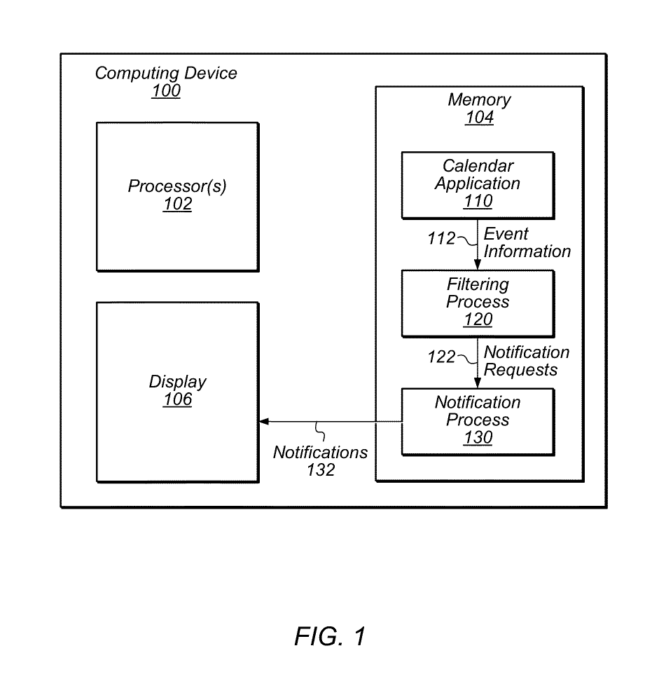

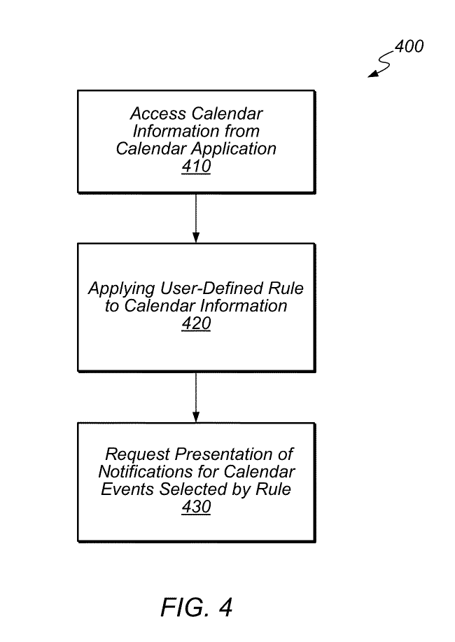

Turning now to FIG. 1, a block diagram of a computing device 100 configured to filter calendar notifications is depicted. In the illustrated embodiment, computing device 100 includes one or more processors 102, memory 104, and a display 106. Memory 104, in turn, includes a calendar application 110, filtering process 120, and notification process 130. Computing device 100 may correspond to any of various computing devices such as those described below with respect to FIG. 4. In some embodiments, computing device 100 may be implemented differently than shown. For example, in some embodiments, filtering process 120 may be included in calendar application 110 or notification process 130. In other embodiments, calendar application 110 and/or filtering process 120 may be located at a computing device other than computing device 100. For example, in one embodiment, calendar application 110 and/or filtering process 120 may be located in a cloud computing system that is coupled to computing device 100 via a wide-area network such as the Internet.

Calendar application 110, in one embodiment, is executable to maintain a calendar that is presented via a graphical interface to a user. Calendar application 110 may allow the user to create calendar events on particular days at particular times. Application 110 may also allow a user to invite others to created calendar events as well as receive invitations from others to calendar events. For example, a user might create an event for a conference call at 10:30 am on February 29^{th} and then invite another user to attend. Calendar application 110 may send an invitation to the other user, which can be accepted or declined. Calendar application 110 may also allow a user to set reminders for calendar events that trigger notifications—e.g., a reminder for a notification fifteen minutes before an event. In some embodiments, calendar application 110 may be implemented by an existing calendar application such as iCal™, Google™ Calendar, Microsoft™ Outlook, etc.

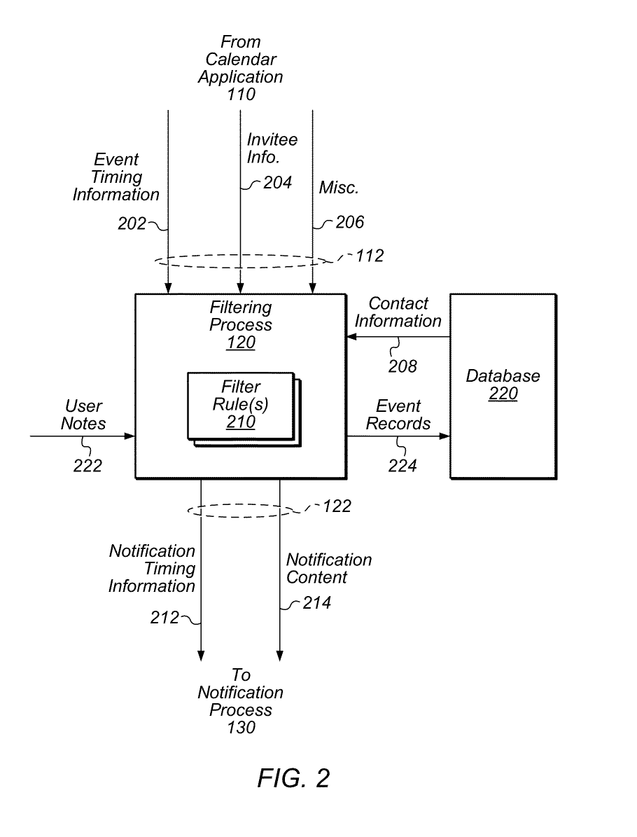

Calendar application 110 may maintain a calendar by storing various forms of event information 112 in a database. As will be described in further detail with respect to FIG. 2, event information 112 may include, without limitation, an event name, the start and end times for the event, the invitees of the event, etc. In various embodiments, event information 112 may be accessible to other processes such as filtering process 120. Accordingly, in some embodiments, filtering process 120 retrieves event information 112 by sending a request to a calendar application 110 via an application-programming interface (API). For example, in one embodiment in which computing device 100 implements Apple's iOS™ operating system, filtering process 120 may retrieve event information 112 by invoking an API call via Apple's Event Kit architecture (an API supported by the operating system for accessing calendar information). Filtering process 120 may retrieve event information 112 periodically or continuously. Alternatively, calendar application 110 may push event information 112 to filtering process 120.

Filtering process 120, in one embodiment, includes program instructions that are executable to filter which notifications are displayed to a user. In the illustrated embodiment, filtering process 120 receives event information 112 from calendar application 110 and applies one or more filtering rules to information 112 to select calendar events that warrant notifications. In various embodiments, these filtering rules are defined by a user of computing device 100. (As used herein, the term “user-defined” refers to a rule that is established by a user. This term may be used to describe custom rules that are built by a user (e.g., through specifying a Boolean expression). This term refers to a pre-defined rule that is selected by a user for use by filtering process 120. This term, however, would not apply to a rule that is automatically implemented, e.g., by a company or other entity such as an information sharing service.) Accordingly, a user may create a rule specifying whether a notification should be presented (or not be presented) for a calendar event based on the calendar event having (or not having) various properties selected by the user. For example, a user might create a rule that specifies a particular email address and dictates that a notification be generated for any calendar event that identifies the email address as an invitee to the event. (More examples of rules are described below with respect to FIG. 2.) In one embodiment, filtering process 120 presents a user interface that allows the user to create filtering rules. In some embodiments, filtering process 120 presents a menu with a set of pre-defined rules that are selectable by a user. In one embodiment, filtering process 120 may allow a user to import rules created remotely—e.g., by the user via a web interface provided by a remote computing system.

Once filtering process 120 has determined that a calendar event warrants a notification, in various embodiments, filtering process 120 issues a corresponding notification request 122 to cause a notification 132 to be displayed for that event. In some embodiments, filtering process 120 issues a notification request 122 to notification process 130 via another API call to the operating system of computing device 100. For example, in one embodiment in which the iOS operating system is used, process 120 may create a UILocalNotification object and invoke scheduleLocalNotification to cause iOS's notification center to present a notification. In illustrated embodiment, notification requests 122 are generated locally (i.e., at computing device 100). In other embodiments in which filtering process is located externally to computing device 100 (e.g., at a remote server system) and notification process 130 is located at computing device 100, notification process 130 may periodically fetch requests 122 from process 120. Accordingly, process 130 may periodically check in with external filtering process 120 and request delivery of any pending requests 122. Alternatively, requests 122 may be pushed to notification process 130 by filtering process 120.

In some embodiments, notification requests 122 may specify when a notification will be presented and/or what the content of the notification will be. For example, as will be described below with respect to FIG. 2, in one embodiment, filtering process 120 may issue notification requests 122 for calendar events that have already occurred (i.e., after their scheduled end times). In such an embodiment, filtering process 120 may request a notification that redirects the user to a form that asks the user to provide notes about the calendar event. In some embodiments, filtering process 120 may store records for calendar events in a database and include the user's notes in these records.

Although filtering process 120 is shown as providing a request 122 directly to notification process 130 in the illustrated embodiment, in other embodiments, filtering process 120 may issue a request 122 indirectly to notification process 130. Accordingly, in some embodiments, filtering process 120 may issue an indirect request by modifying event information 112 in calendar application 110 to cause calendar application 110 to directly request a notification 132 from notification process 130. For example, in one embodiment, filtering process 120 may modify a reminder for a calendar event, which may be an existing reminder or a newly created one for the calendar event.

Notification process 130, in one embodiment, is executable to display notifications 132 on display 106. In some embodiments, notification process 130 may be integrated into an operating system of computing device 100. For example, in one embodiment, process 130 implements the notification center in iOS. In some embodiments, process 130 may be part of calendar application 110 (or some other application). Notifications 132 may take any of various forms. Notifications 132 may include text and/or icons and be accompanied with sounds. In one embodiment, notifications 132 are alerts that display in the middle of the screen prompting the user to take action. In one embodiment, notifications 132 are banners that appear at an edge of the screen (e.g., the top) and disappear after an interval. In one embodiment, notifications 132 are badges that appear over a process's desktop icon. While notifications 132 are depicted as being provided to display 106, in some embodiments, notifications 132 may be audible-only notifications presented via a speaker of computing device 100.

Turning now to FIG. 2, a block diagram of filtering process 120 is depicted. In the illustrated embodiment, filtering process 120 includes a set of filter rules 210 and receives event information 112 that includes event timing information 202, invitees 204, and miscellaneous information 206. As will be described below, filtering process 120 may apply rules 210 to any combination of elements 202-206 as well as contact information 208 in order to determine which calendar events warrant notifications. In the illustrated embodiment, filtering process 120 issues notification requests 122 that include notification timing information 212 and notification content 214. As will be discussed, filtering process 120 may also receive user notes 222 for creating event records 224 to be stored in database 220.

Event timing information 202, in one embodiment, is information that identifies when calendar events are scheduled. Information 202 may include any information relating to the timing of an event, including, without limitation, start times (e.g., February 29^{th} at 2 pm EST), durations (e.g., 30 minutes), end times (e.g., 2:30 pm EST), reoccurrence information (e.g., this event repeats once a month until a specified end date). In various embodiments, filtering process 120 uses information 202 to determine notification timing information 212. For example, filtering process 120 may specify timing information 212 that causes a notification to be presented fifteen minutes after an end time specified by information 202. Filtering process 120 may also apply filtering rules 210 to this information as discussed below.

Invitee information 204, in one embodiment, identifies the people invited to attend shared calendar events. Invitee information 204 may identify individuals in any of various ways. Accordingly, in some embodiments, invitees may be identified by their actual names, email addresses, social media account names, user names, etc. In some embodiments, invitee information 204 may also include invitation replies such as whether a person is attending, maybe attending, not attending, or not responsive.

Miscellaneous information 206 is representative of other information that may be received from calendar application 110. In some embodiments, information 206 may include location information about where a calendar event will occur, contact information for an event (e.g., a conference number), and/or notes recorded by an event creator. In some embodiments, information 206 may include an indication of whether a reminder has been set for a calendar event—e.g., an indication to remind the user of the event fifteen minutes beforehand.

Contact information 208, in one embodiment, is a list of contacts for a user with information about those contacts. For example, information 208 may specify a person's name, email address, and/or phone number. In some embodiments, information 208 may identify the employer of a person—e.g., that the person works at Salesforce™. In some embodiments, information 208 may identify business relationship information such as whether a particular person is a sales lead of the user, a supervisor of the user, etc. In the illustrated embodiment, contact information 208 is received from database 220 discussed below. In other embodiments, contact information 208 may be received from another source (e.g., a contacts application or file on computing device 100, stored at a remote computer system, etc.).

Filtering rules 210, in one embodiment, are user-defined rules that dictate whether a notification should be generated for a calendar event. As noted above, rules 210 may take any of various forms. In general, a rule 210 may dictate an action (e.g., suppress a notification or generate a notification) performed based on a property or properties of a calendar event.

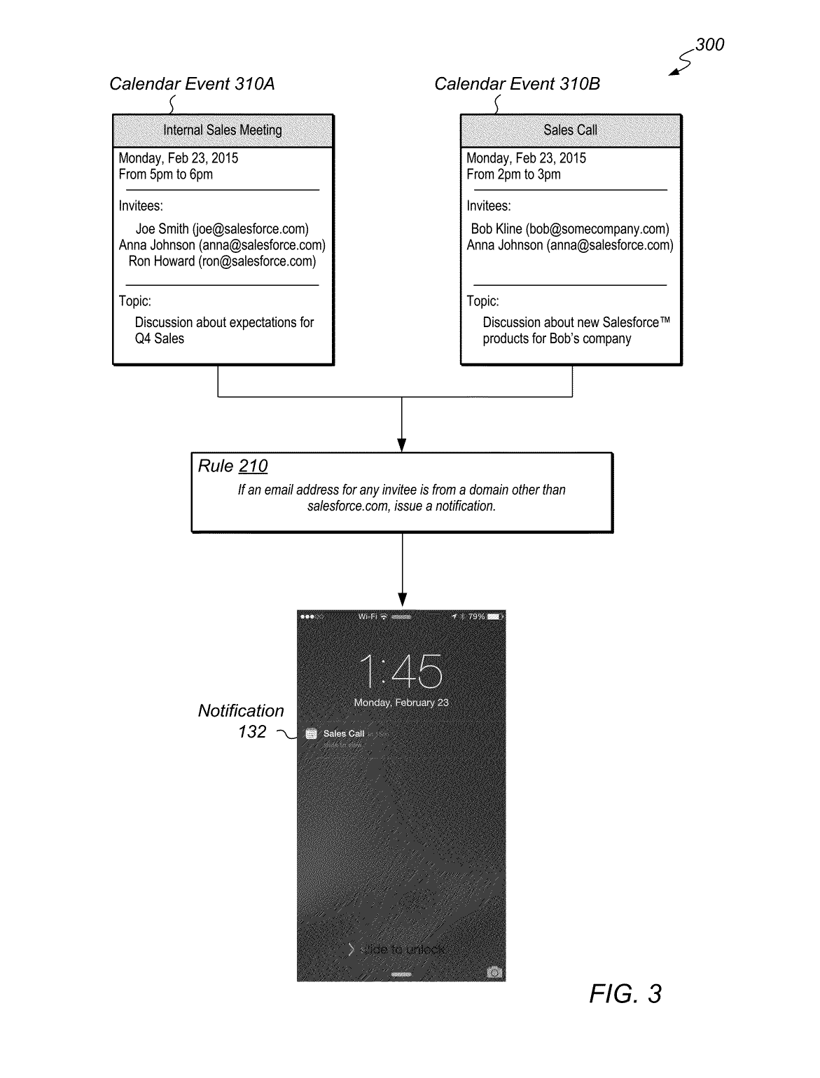

Accordingly, in some embodiments, these properties may be properties of event invitees. For example, in one embodiment, a user may create a rule 210 that specifies an identifier of a particular person (e.g., name, email address, etc.) and causes a notification to be presented (or not presented) based on whether that person is an invitee. In such an embodiment, the rule 210 may also consider whether the person responded to the invitation and how the person responded (i.e., whether the person is attending, maybe attending, or not attending). In one embodiment, a user may create a rule that specifies a particular employer and causes a notification to be presented (or not presented) based on whether any invitees are employed by that employer. In some embodiments, filtering process 120 may determine employer information for invitees from contact information 208. In another embodiment, filtering process 120 may determine an employer based on a domain name in an invitee's email address. For example, it may be possible to discern that Joe works at Salesforce from the email address joe@salesforce.com. In such an embodiment, a rule 210 might be created for the domain name salesforce.com (as discussed below with respect to FIG. 3). In this manner, Joe can create a rule 210 that filters notifications based on whether a calendar event has internal or external invitees (invitees that work at the same company as Joe—i.e., Salesforce™). Thus, Joe could avoid, for example, notifications for internal meetings (i.e., meetings with just Salesforce employees), but receive notifications for external meetings (i.e., meetings that include an external invitee). In one embodiment, a rule 210 may be created based on a business relationship that an invitee has with the user. For example, a user may create a rule that causes a notification to be presented in response to an invitee being a lead for a potential sale by the user. In some embodiments, filtering process 120 may determine whether this relationship exists based on contact information 208.

In some embodiments, properties specified by rules 210 may be properties other than invitee properties. For example, in some embodiments, a rule 210 may be created based on when a calendar event is scheduled, how long the event is, etc. In one embodiment, a rule 210 may be created based on location information about the calendar event (e.g., if the event is a meeting in San Francisco as indicated by miscellaneous information 206). In one embodiment, a rule 210 may be created based on whether a reminder had been previously set for a calendar event. (Such a rule might override other rules that dictate not presenting a notification.) In one embodiment, a rule 210 may be created to issue a notification based on whether an event record 224 (discussed below) has already been stored in database 220 for a calendar event.

As noted above, once a rule 210 has indicated that a notification should be issued, filtering process 120 may issue a notification request 122 that includes notification timing information 212 and notification content 214.

Notification timing information 212, in one embodiment, is indicative of when a notification should be issued. For example, information 212 may specify that a notification occur at 5 pm EST on February 29^{th}. As noted above, filtering process 120 may issue requests for any suitable time for a calendar event, including before, during, or after the event. (In some embodiments, timing information 212 may specify a value that causes a notification to not to be presented.)

Notification content 214, in one embodiment, is the content to be included in a notification. Content 214 may specify text to be included, sounds to be played, and/or a type of notification to be presented. For example, content 214 might specify the name of an event, the invitees to the event, and an indication that the notification be displayed as a banner at the top of display 106.

In some embodiments, notification content 214 may be displayed so as to ask a user to provide additional information for a calendar event to create an event record 224. (As used herein, the phrase “event record” refers broadly to the storage of information about a calendar event.) For example, in one embodiment, display of content 214 may prompt the user whether he/she wants to create an event record. Upon selection of the selection of the notification (e.g., via display 106, which is a touch screen in some embodiments), the user may be redirected to a form that asks various questions about the event and includes fields for entering responses such as meeting details, the contact associated with the event, and the start and end times of the event. Upon completion, a corresponding event record 224 may be created for the event. In the illustrated embodiment, filtering process 120 collects this information as user notes 222. Accordingly, selecting the notification may redirect the user to filtering process 120, which provides a form to be completed by the user. In such an embodiment, filtering process 120 may create an event record 224 that includes user notes 222 along with a portion of event information 112. In other embodiments, however, user notes 222 may be collected in a manner differently from that shown. For example, in one embodiment, content 214 may include a URL that redirects the user to website to complete a form there.

Database 220, in one embodiment, is configured to store event records 224. In some embodiments, database 220 is located at computing device 100. In other embodiments, database 220 is located remotely from (i.e., externally to) computing device 100. In such an embodiment, for example, database 220 may be stored in a cloud computing system that is accessible to computing device 100 over a computer network such as the Internet. In various embodiments, database 220 also permits querying event records 224 to obtain information from records 224. Thus, a user may be able to retrieve notes for a particular event such as the sales lead that attended the event. As noted above, database 220 may also store contact information 208 and provide information 208 upon request.

Turning now to FIG. 3, an example of filtering notifications is shown. In the illustrated embodiment, a user has two calendar events 310A and 310B that are being evaluated by filtering process 120. Calendar event 310A pertains to an internal sales meeting being attended by Salesforce™ employees to discuss expectations about Q4 product sales. Calendar event 310B pertains to a meeting for a potential lead Bob Kline, who might be interested in buying a new product. The user has defined a rule 210 that indicates that a notification is desired if an email address for any invitee is from a domain other than salesforce.com. When this rule is applied to calendar event 310A, the event is not selected because none of the invitees meets this criterion. In contrast, calendar event 310B includes an invitee that does meet this criterion, as bob@somecompany.com specifies a domain other than salesforce.com. Thus, a request to present a notification 132 for calendar event 310B is made.

Turning now to FIG. 4, a flowchart of a method 400 for filtering notifications is shown. In one embodiment, method 400 is performed by a computing device on which the notifications are presented such as computing device 100 executing filtering process 120. In another embodiment, method 400 is performed by a separate computing system—e.g., a remote computing system that communicates over a computer network with the computing device on which the notifications are presented.

In step 410, calendar information (e.g., event information 112) is accessed from a calendar application (e.g., calendar application 110) that maintains a calendar for a user. In such an embodiment, the calendar information identifies calendar events of the user. This calendar information may include any of various types of information discussed above, including information that identifies the invitees for calendar events. In some embodiments, step 410 includes issuing a first application programming interface (API) call to an operating system of the computing device. In such an embodiment, the first API call requests the event information from the calendar application (e.g., an API call to iOS via Apple's Event Kit architecture).

In step 420, a user-defined rule (e.g., filtering rules 210) is applied to the calendar information. In some embodiments, the rule specifies a property of an invitee to a calendar event, and step 420 includes a determination of whether to present a notification (e.g., notifications 132) for a calendar event based on an invitee of the calendar event having the property. In some embodiments, the determination is based on contact information of the user that is retrieved from a database (e.g., contact information 208 from database 220) external to the computing system In one embodiment, the filtering rule specifies that the notification be presented based on the contact information identifying the invitee as a sales lead. In one embodiment, the filtering rule specifies that the notification be presented based on a domain name (e.g., salesforce.com) present in an email address (e.g., joe@salesforce.com) for one of the invitees. In various embodiments, step 420 includes applying a plurality of rules to the calendar information.

In step 430, presentation of notifications for one or more calendar events selected by the rule is requested (e.g., via notification requests 122). In some embodiments, the one or more notifications are presented at a computing device (e.g., computing device 100) that is coupled to the computing system (e.g., a computing system external to computing device 100) via a computer network. In various embodiments, the presented notifications include a notification that is presented after an event has occurred. In such an embodiment, the notification redirects the user to a form that asks the user for notes about the event (e.g., user notes 222). In such an embodiment, step 430 may include storing a record for the event at a remote database that includes the notes about the event. (Method 400 may further include querying the remote database for information in the record.) In some embodiments, step 430 includes issuing a second API call to a notification process (e.g., a notification request 122 to notification process 130) of the operating system. In such an embodiment, the second API call requests that the notification process display a notification on the display of computing device

### Exemplary Computer System

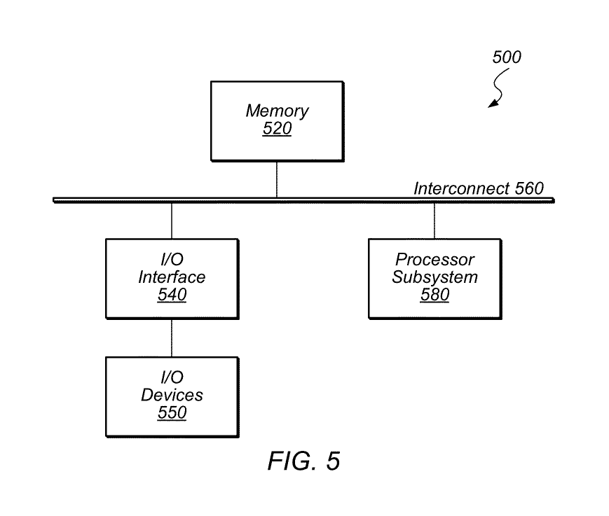

Turning now to FIG. 5, a block diagram of an exemplary computer system 500, which may implement computing device 100, is depicted. Computer system 500 includes a processor subsystem 580 that is coupled to a system memory 520 and I/O interfaces(s) 540 via an interconnect 560 (e.g., a system bus). I/O interface(s) 540 is coupled to one or more I/O devices 550. Computer system 500 may be any of various types of devices, including, but not limited to, a server system, personal computer system, desktop computer, laptop or notebook computer, mainframe computer system, tablet computer, handheld computer, workstation, network computer, a consumer device such as a mobile phone, music player, or personal data assistant (PDA). Although a single computer system 500 is shown in FIG. 5 for convenience, system 500 may also be implemented as two or more computer systems operating together.

Processor subsystem 580 may include one or more processors or processing units. In various embodiments of computer system 500, multiple instances of processor subsystem 580 may be coupled to interconnect 560. In various embodiments, processor subsystem 580 (or each processor unit within 580) may contain a cache or other form of on-board memory. In one embodiment, processor subsystem 580 may include processor(s) 102 described above.

System memory 520 is usable store program instructions executable by processor subsystem 580 to cause system 500 perform various operations described herein. System memory 520 may be implemented using different physical memory media, such as hard disk storage, floppy disk storage, removable disk storage, flash memory, random access memory (RAM—SRAM, EDO RAM, SDRAM, DDR SDRAM, RAMBUS RAM, etc.), read only memory (PROM, EEPROM, etc.), and so on. Memory in computer system 500 is not limited to primary storage such as memory 520. Rather, computer system 500 may also include other forms of storage such as cache memory in processor subsystem 580 and secondary storage on I/O Devices 550 (e.g., a hard drive, storage array, etc.). In some embodiments, these other forms of storage may also store program instructions executable by processor subsystem 580. In some embodiments, memory 104 described above may include (or be included within) system memory 520.

I/O interfaces 540 may be any of various types of interfaces configured to couple to and communicate with other devices, according to various embodiments. In one embodiment, I/O interface 540 is a bridge chip (e.g., Southbridge) from a front-side to one or more back-side buses. I/O interfaces 540 may be coupled to one or more I/O devices 550 via one or more corresponding buses or other interfaces. Examples of I/O devices 550 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 500 is coupled to a network via a network interface device 550 (e.g., configured to communicate over WiFi, Bluetooth, Ethernet, etc.).

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

1. A non-transitory computer readable medium having program instructions stored thereon that are capable of causing a computing device to implement operations comprising:
retrieving event information from a calendar application of the computing device, wherein the event information identifies a plurality of events for a user of the computing device and identifies a plurality of invitees for a particular one of the plurality of events;
selecting one or more of the plurality of events by applying a filtering rule to the event information, wherein the filtering rule is defined by the user and specifies that a notification be presented for the particular event based on one or more properties of the plurality of invitees; and
presenting notifications for the selected one or more events on a display of the computing device.

2. The computer readable medium of claim 1, wherein the one or more properties include an attendance indication provided by one or more of the plurality of invitees.

3. The computer readable medium of claim 1, wherein the one or more properties include a domain name present in an email address for one of the plurality of invitees.

4. The computer readable medium of claim 1, wherein the operations further include:
retrieving contact information of the user, wherein the contact information identifies one of the plurality of invitees as a sales lead of the user; and
wherein the one or more properties include the contact information identifying the invitee as a sales lead.

5. The computer readable medium of claim 1, wherein the presented notifications include a notification that is presented after an event has concluded.

6. The computer readable medium of claim 5, wherein the notification directs the user to a form that asks the user for notes about the event.

7. The computer readable medium of claim 6, wherein the operations further include:
storing a record for the event at a remote database, wherein the record includes the notes about the event; and
querying the remote database for information in the record.

8. The computer readable medium of claim 1, wherein the retrieving includes issuing a first application programming interface (API) call to an operating system of the computing device, wherein the first API call requests the event information from the calendar application.

9. The computer readable medium of claim 8, wherein the presenting includes issuing a second API call to a notification process of the operating system, wherein the second API call requests that the notification process display a notification on the display of the computing device; and
wherein the computing device is a mobile device configured to communicate wirelessly.

10. A non-transitory computer readable medium having program instructions stored thereon that are capable of causing a computer system to implement operations comprising:
storing notification information for shared calendar events, wherein the notification information identifies a particular user as an event invitee to the shared calendar events and identifies a plurality of event invitees for a shared calendar event;
storing at least one notification filtering rule defined by the particular user, wherein the notification filtering rule specifies a property for event invitees and dictates that the shared calendar event be selected based on the event invitees of the shared calendar event having the property;
applying the notification filtering rule to the notification information to select a group of one or more shared calendar events; and
causing presentation of one or more notifications for the selected group of shared calendar events to the particular user.

11. The computer readable medium of claim 10, wherein the property is an event invitee having a particular email address specified by the notification filtering rule.

12. The computer readable medium of claim 10, wherein the property is an event invitee having a particular employer, and wherein the at least one notification filtering rule dictates that the shared calendar event be selected based on whether one or more of the event invitees of the shared calendar event are employees of the particular employer.

13. The computer readable medium of claim 10, wherein the operations further comprise:
retrieving the notification information from a calendar application of the computer system, wherein the calendar application is executable to display a calendar with the shared calendar events.

14. The computer readable medium of claim 10, wherein the causing includes causing presentation of a notification for a calendar event in the selected group after a start time of the calendar event.

15. The computer readable medium of claim 10, wherein the one or more notifications include a notification that solicits input from the particular user about a shared event; and
wherein the operations further comprise:
transmitting the solicited input to a database via a computer network.

16. A method, comprising:
a computing system accessing calendar information from a calendar application that maintains a calendar for a user, wherein the calendar information identifies calendar events of the user;
the computing system applying a rule defined by the user to the calendar information, wherein the rule specifies a property of an invitee to a calendar event, and wherein the applying includes a determination of whether to present a notification for a first of the calendar events based on an invitee of the first calendar event having the property; and
the computing system requesting presentation of notifications for one or more calendar events selected by the rule.

17. The method of claim 16, wherein the requesting is performed after conclusion of the one or more calendar events.

18. The method of claim 16, wherein the determination is based on contact information of the user that is retrieved from a database external to the computing system.

19. The method of claim 16, wherein the applying includes applying a plurality of rules to the calendar information, wherein the plurality of rules includes a first rule that dictates that a notification not be presented based on one or more properties of invitees, and wherein the plurality of rules includes a second rule that dictates that a notification be presented based on a time at which a calendar event is to begin.

20. The method of claim 16, wherein the notifications are presented at a computing device that is coupled to the computing system via a computer network.
